(19) United States
(12) Patent Application Publication
(10) Pub. No.: US 2005/0007522 A1
(43) Pub. Date: Jan. 13, 2005

(54) Liquid crystal display device

(76) Inventors: Koji Hiraga, Ooamishirasato (JP); Tetsuya Nagata, Mobara (JP); Takehiko Kubota, Mobara (JP); Takahiro Fujioka, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/886,644

(22) Filed: Jul. 9, 2004

(30) Foreign Application Priority Data
Jul. 9, 2003 (JP) 2003-194009

(51) Int. Cl. G02F 1/1335

(52) U.S. Cl. 349/106

(57) ABSTRACT

The color characteristics of a semi-transmissive type liquid crystal display device are enhanced in a liquid crystal display device which includes a first substrate on which a plurality of pixel electrodes are formed, a second substrate which faces the first substrate in an opposed manner, color filters which are formed between the first substrate and the second substrate, reflection members which reflect light incident from the second substrate side, and a backlight which is provided at the outside of the first substrate In the color filters which correspond to first pixel electrodes opening portions are formed from sides close to a first side of the first substrate, and in the color filters which correspond to second pixel electrodes, opening portions are formed from sides close to the second side of the first substrate which faces the first side in an opposed manner.

### BACKGROUND OF THE INVENTION

The present invention relates to a liquid crystal display device, and, more particularly to a so-called partial-transmissive type liquid crystal display device.

A so-called partial-transmissive type liquid crystal display device is mounted on a mobile phone, a digital still camera or the like, and it allows the recognition of an image on a display screen using either one of reflected light from the sun and light from a backlight incorporated in the device, depending on the conditions. That is, of respective transparent substrates which are arranged to face each other with liquid crystal disposed therebetween, on a liquid-crystal-side surface of one transparent substrate, regions which are surrounded by gate signal lines which extend in the x direction and drain signal lines which extend in the y direction are formed as pixel regions. In each pixel region, there are a thin film transistor which is driven in response to the supply of a scanning signal from one gate signal line and a pixel electrode to which a video signal is supplied from one drain signal line through the thin film transistor.

The pixel electrode is formed of a transparent electrode, such as ITO (Indium-Tin-Oxide), for example. An electric field is generated between the pixel electrode, and a counter electrode which is formed in common with respective pixel regions and is formed of a transparent electrode on a liquid-crystal-side surface of the other transparent substrate, and the optical transmissivity of the liquid crystal in the pixel region is controlled in response to the electric field. By providing a reflection plate made of metal or the like for each one of the respective pixel regions, each pixel region is imparted with two functions corresponding to the respective portions thereof, that is, a function of producing a reflective display in the portion where the reflection plate is formed (reflection display region) and a function of producing a transmissive display in the portion where the reflection plate is not formed (transmissive display region).

The constitution of this type of liquid crystal display device is described in detail in JP-A-11-101992 or JP-A-11-242226. With respect to such a liquid crystal display device, the liquid crystal display device which is constructed to provide a color display has color filters of red (R), green (G) and blue (B) formed on a liquid-crystal-side surface of the other transparent substrate in an opposed manner with regard to respective pixel regions.

Color filters of the partial-transmissive-type liquid crystal display device employ a deep color filter resist for enhancing the characteristics thereof at the time of producing a transmissive display. However, at the time of producing a reflective display, light which is incident after passing through the color filter is reflected on the reflection plate and is displayed to the outside after passing through the color filter again. Accordingly, at the time of producing a reflective display, the light passes through the color filter twice, and, hence, the reflectance is largely decreased, thus deteriorating the characteristics of the reflective display. To prevent such a drawback, it has been proposed to provide a liquid crystal display device having a constitution in which a cut or an opening portion is formed in the reflective display region, that is, the region where the reflective member is formed. This constitution is described in detail in JP-A-2002-341366.

### SUMMARY OF THE INVENTION

As described above, by providing a cut (or opening portion) in the color filter of the partial transmissive type (also referred to as a semi-transmissive type) liquid crystal display device, the reflective characteristics can be enhanced even when a deep (having high color purity) color filter is used. However, there arises a drawback in that irregularities are generated in the reflective characteristics among respective colors. Further, in an extremely-high-definition liquid crystal display device, such as a liquid crystal display device which uses low-temperature polysilicon, a restriction is imposed on the resolution of a photolithography process in forming the opening portion in the color filter, and, hence, it is difficult to form the opening portion in the reflective region as in the case of the related art. Further, when a client demands a constitution in which the transmissive region should be larger than the reflective region, it becomes even more difficult to form the opening portion in the reflective region. Further, there has been also a drawback in that misalignment at the time of assembling a TFT substrate and a color filter substrate, which constitute the liquid crystal display device, also extremely affects the display characteristics.

Accordingly, it is a first object of the present invention to provide a liquid crystal display device in which the reflective characteristics of color filters can be enhanced for every color.

It is a second object of the present invention to provide a liquid crystal display device which enables the formation of openings in color filters having high color purity, which are conventionally used, even with respect to a high-definition liquid crystal display device, whereby the influence of misalignment of the substrates can be reduced.

To describe a representative example of the liquid crystal display device among the liquid crystal display devices of the present invention disclosed in this specification, the liquid crystal display device includes a first substrate on which a plurality of pixel electrodes are formed, a second substrate which faces the first substrate in an opposed manner, color filters which are formed between the first substrate and the second substrate, reflection members which reflect light incident from the second substrate side, and a backlight which is provided at the outside of the first substrate. In the color filters which correspond to first pixel electrodes among the plurality of pixel electrodes, opening portions are formed from sides close to a first side of the first substrate, and in the color filters which correspond to second pixel electrodes among the plurality of pixel electrodes, opening portions are formed from sides close to a second side of the first substrate which faces the first side in an opposed manner.

Here, the color filters which correspond to the first pixel electrodes and the color filters which correspond to the second pixel electrodes are red color filters, and the first pixel electrodes and the second pixel electrodes are connected with the same drain line and are connected with neighboring gate lines.

Further, the liquid crystal display device may have a constitution in which the liquid crystal display device includes third pixel electrodes which are connected to the gate line to which the first pixel electrodes are connected and are arranged close to the first pixel electrodes and fourth pixel electrodes which are connected to the gate line to which the first pixel electrodes are connected and are arranged close to the third pixel electrodes, wherein the color filters which correspond to the third pixel electrodes are green color filters, the color filters which correspond to the fourth pixel electrodes are blue color filters, and opening portions are formed in the color filters which correspond to the third pixel electrodes.

Further, the opening portions formed in the color filters corresponding to the third pixel electrodes may be formed from sides close to the first side.

Further, the opening portions formed in the color filters corresponding to the third pixel electrodes may be formed from sides close to the second side.

Further, the area of the opening portion formed in the color filter corresponding to the third pixel electrode may be set so as to be larger than the area of the opening portion formed in the color filter corresponding to the first pixel electrode.

Further, the opening portions formed in the color filters corresponding to the third pixel electrodes may be formed from the first side to the second side.

Here, according to a liquid crystal display device having a constitution different from the above-mentioned constitution, the liquid crystal display device includes a first substrate on which a plurality of pixel electrodes are formed, a second substrate which faces the first substrate in an opposed manner, color filters which are formed between the first substrate and the second substrate, reflection members which reflect light incident from the second substrate side, and a backlight which is provided at the outside of the first substrate. In the color filters which correspond to first pixel electrodes among the plurality of pixel electrodes, opening portions are formed from sides close to the first side of the first substrate, and in the color filters which correspond to second pixel electrodes among the plurality of pixel electrodes, opening portions are formed from sides close to the second side of the first substrate which faces the first side in an opposed manner. Here, the first pixel electrodes and the second pixel electrodes are connected to the same gate line. The color filters corresponding to the first pixel electrodes and the color filters corresponding to the second pixel electrodes are red color filters, and between the first pixel electrode and the second pixel electrode, the third pixel electrode displaying green and the fourth pixel electrode displaying blue, which are connected to the gate line, are formed.

Here, the color filter corresponding to the third pixel electrode may be configured to have an opening portion formed from a side close to the first side.

Here, the color filter corresponding to the third pixel electrode may have an opening portion formed from a side close to the second side.

Further, the area of the opening portion formed in the color filter corresponding to the third pixel electrode may be set so as to be larger than the area of the opening portion formed in the color filter corresponding to the first pixel electrode.

Further, the opening portions formed in the color filters corresponding to the third pixel electrodes may be formed from the first side to the second side.

Further, the liquid crystal display device may be configured to include fifth pixel electrodes which are connected to the gate line arranged close to the gate line and to the drain line to which the first pixel electrodes are connected and which display red, wherein the color filter corresponding to the fifth pixel electrode includes an opening portion arranged close to the first side.

Further, the liquid crystal display device may be configured to include fifth pixel electrodes which are connected to the gate line arranged close to the gate line and to the drain line to which the first pixel electrodes are connected and which display red, wherein the color filter corresponding to the fifth pixel electrode includes an opening portion arranged close to the second side.

Further, there is an arrangement in which an opening portion is not formed in the color filter corresponding to the fourth pixel electrode. Further, a spacer may be formed over the fourth pixel electrode.

The reflection members may be metal films which are formed between the first substrate and the second substrate and the reflection members may be electrically connected with the plurality of respective pixel electrodes. Further, the reflection members may be formed in the backlight.

Further, a counter electrode may be formed over either one of the second substrate and the first substrate.

Objects, the constitution and advantageous effects other than the above-mentioned objects of the invention will become apparent in view of the description provided in this specification and the attached drawings.

### BRIEF DESCRIPTION OF THE DRAWINGS

FIG. 1 is a diagram showing the constitution of color filters of the first embodiment of the present invention;

FIG. 2 is a schematic diagram showing the constitution of a display panel of the present invention;

FIG. 3 is a diagram showing the constitution of a TFT substrate of the present invention;

FIG. 4 is a diagrammatic sectional view showing cross sections taken along a line IV-IV in FIG. 1 and FIG. 3;

FIG. 5 is a diagram showing the constitution of color filters of the second embodiment of the present invention;

FIG. 6 is a diagram showing the constitution of color filters of the third embodiment of the present invention;

FIG. 7 is a diagram showing the constitution of color filters of the fourth embodiment of the present invention;

FIG. 8 is a diagram showing the constitution of a TFT substrate of the fifth embodiment of the present invention;

FIG. 9 is a diagram showing the constitution of color filters of the fifth embodiment of the present invention;

FIG. 10 is a diagram showing the constitution of color filters of the sixth embodiment of the present invention;

FIG. 11 is a diagram showing the constitution of color filters of another embodiment of the present invention; and

FIG. 12 is a diagram showing the constitution of color filters of still another embodiment of the present invention.

### DESCRIPTION OF THE PREFERRED EMBODIMENTS

Various embodiments of a liquid crystal display device according to the present invention will be explained hereinafter in conjunction with the drawings.

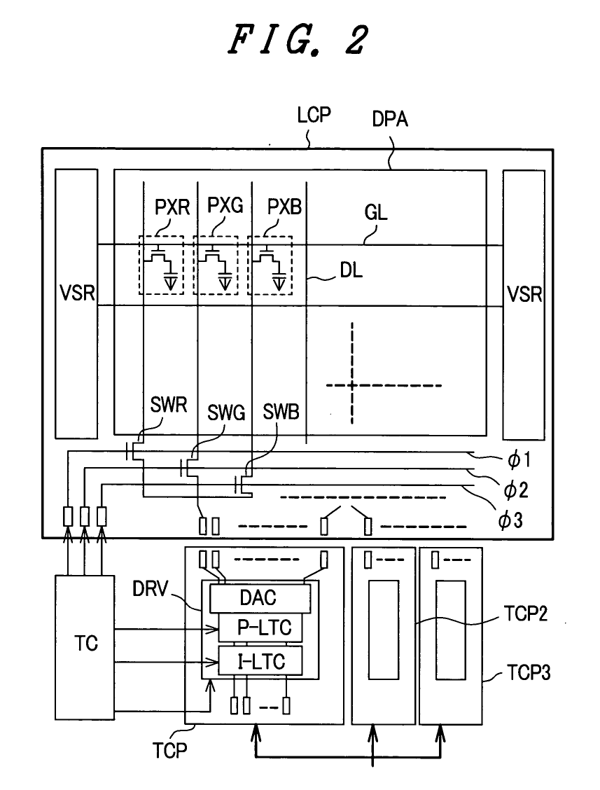

FIG. 2 is a view showing an example of a liquid crystal display device constituting a first embodiment of the present invention. Here, of a pair of substrates which constitute the liquid crystal display device, a TFT substrate on which thin film transistors are formed in an array is shown. The liquid crystal display device of the present invention requires, besides a display panel constituted of the above-mentioned pair of substrates, constitutional elements, such as a diffusion plate, polarizers, a light guide plate and a backlight, which includes a cold cathode ray tube, a light emitting diode or the like. However, these constitutional elements are omitted from the drawing.

On a display panel LCP, a plurality of scanning lines GL extend in the lateral direction and, at the same time, a plurality of drain lines DL which extend in the longitudinal direction are formed. At a crossing point where scanning line GL and a drain line DL cross each other, a thin film transistor is formed such that the thin film transistor has the gate thereof connected to the scanning line GL, and either one of a drain and the source thereof is connected to the drain line DL and the other of the drain and a source thereof is connected to a pixel electrode. On the display panel LCP, a plurality of pixels, each of which includes a thin film transistor and a pixel electrode, are arranged in a matrix array. In FIG. 2, among the plurality of pixels which are formed in the matrix array, only the pixel PXR displaying red, the pixel PXG displaying green and the pixel PXB displaying blue, which are connected to one scanning line GL, are shown. In an actual display region, three pixels as shown in the drawing are repeatedly formed. In this embodiment, the size of the display region on which the pixels are formed in a matrix array is 2.2 inches and the resolution is QVGA. This implies that 320 dots are formed in the longitudinal direction and 240 dots are formed in the lateral direction within the display region. That is, in this embodiment, 720 pixels are formed in the lateral direction within the display region. Although the display panel is elongated in the longitudinal direction in this embodiment, the display panel may be elongated in the lateral direction. In this case, 320 dots are formed in the lateral direction and 240 dots are formed in the longitudinal direction. That is, 960 pixels are formed in the lateral direction. It is needless to say that the resolution is not restricted to QVGA.

In producing a display, by selecting a scanning line so as to turn on the thin film transistors which are connected to the scanning line, video signals which are supplied to the drain line are applied to the pixel electrodes. Accordingly, the liquid crystal composition which is interposed between the pixel electrodes and a counter electrode is driven so as to control the optical transmissivity of the liquid crystal composition between the electrodes, whereby a display is produced. The scanning lines extend to the outside of the display region where the pixels are formed in a matrix array, and they are connected to gate drivers VSR at left and right sides which are outside of the display region. Although the drain lines also extend to the outside of the display region, in this liquid crystal display device, the drain line which is connected to the pixel displaying red is connected to one terminal of a switch SWR, the drain line which is connected to the pixel displaying green is connected to one terminal of a switch SWG, and the drain line which is connected to the pixel displaying blue is connected to one terminal of a switch SWB. Other terminals of the three switches which are connected to the drain lines for RGB are assembled into one terminal, and this terminal is connected to a video signal input terminal formed over the display panel. These switches are individually controlled in response to signals Φ1 to Φ3. That is, the switch which corresponds to the pixel indicating red is controlled in response to a signal Φ1, the switch which corresponds to the pixel indicating green is controlled in response to a signal Φ2, and the switch which corresponds to the pixel indicating blue is controlled in response to a signal Φ3. All drain lines which are connected with the pixels displaying red within the display region are connected to the video signal input terminal via the switch which is controlled in response to the signal Φ1, and the same goes for the pixels displaying green and the pixels displaying blue. The video signal input terminal which is formed over the display panel is connected to a terminal of a tape carrier package through an anisotropic conductive sheet or the like, and they are connected with a drain driver mounted on the tape carrier package. Three signals which control the switches formed over the display panel are supplied from an external control circuit TC provided outside the display panel.

The above-mentioned thin film transistors that are formed within the pixel and the thin film transistors which are formed between the drain lines and the drain driver are formed of low-temperature polysilicon. However, the whole or a portion of the gate driver also may be formed of low-temperature polysilicon. Further, although the drain driver is provided outside the substrate, it is possible to form the drain driver IC on the substrate. It is also possible to form the drain driver per se using low-temperature polysilicon. It is needless to say that although these components are formed of low-temperature silicon in this embodiment, the material of the drain driver is not limited to low-temperature silicon, and it is possible to form them using silicon which is closer to single crystal. Further, there is no problem in using amorphous silicon. Although three drain lines are driven by time-division processing in FIG. 2, the driving configuration is not limited to such a configuration and it is possible to adopt a general driving configuration in which the respective drain lines are individually connected to the drain driver.

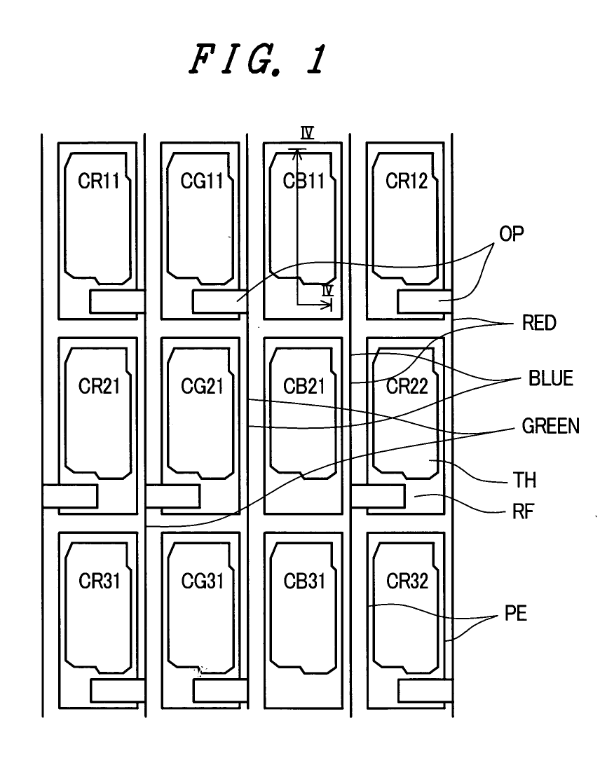

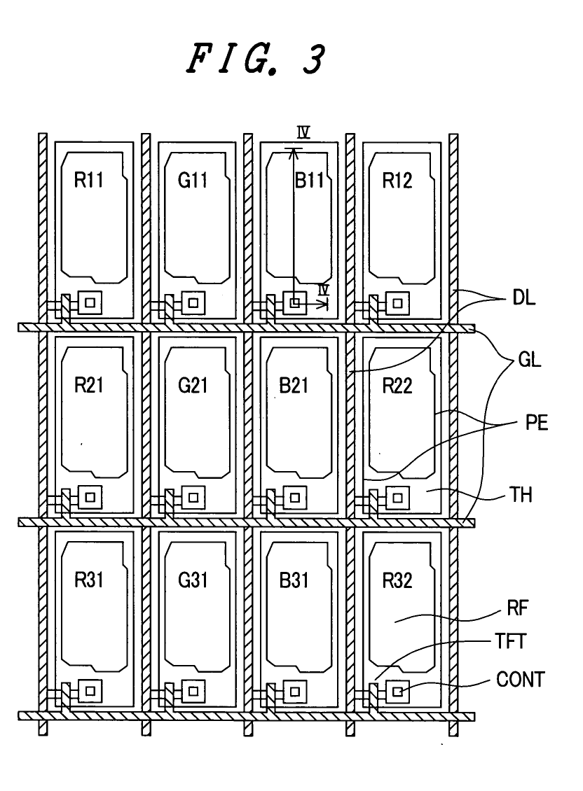

FIG. 3 is a view showing the pixel region on the TFT substrate shown in FIG. 1. To facilitate an explanation of the present invention, only some pixels out of a plurality of pixels formed over the TFT substrate are indicated. Four pixels are formed along the gate line GL, which extends in the lateral direction, and three pixels are formed along the drain line DL, which extends in the longitudinal direction, whereby twelve pixels are shown in the drawing as a whole. Each pixel includes a thin film transistor TFT (since the symbol in the drawing also indicates TFT, the description of symbols in the drawing is omitted hereinafter) and a pixel electrode. Each thin film transistor has the gate electrode thereof connected to a gate line, the drain electrode thereof connected to a drain line, and the source electrode thereof connected to the pixel electrode.

The gate line which is shown at an uppermost portion of the drawing is connected with the pixel electrodes which the respective pixels include via the thin film transistors in respective pixels R11, G11, B11, R12, from the left side in the drawing. The next gate line, which is arranged close to the above-mentioned gate line, is connected to the pixel electrodes via the thin film transistors in the pixels R21, G21, B21, R22. Further, the next gate line which is arranged close to the previous gate line is connected to the pixel electrodes of the respective pixels via the thin film transistors in the pixels R31, G31, B31, R32. On the other hand, the drain line which is formed at the leftmost portion in the drawing is connected to the pixel electrodes of the respective pixels via the thin film transistors in the pixels R11, R21, R31, and the next drain line which is arranged close to the previous drain line is connected to the pixel electrodes of the respective pixels via the thin film transistors in the pixels G11, G21, G31. R, G, B affixed to the symbols which indicate the pixels indicate the colors displayed by the respective pixels. The pixels such as R11, R21 are combined with red color filters to be described later so as to display the color red. In the same manner, the pixels such as G11, G21 display the color green, and the pixels such as B11, B21 display the color blue.

FIG. 1 is an enlarged view of the counter substrate which is arranged to face the TFT substrate shown in FIG. 2 and FIG. 3 in an opposed manner in the display panel of the present invention. On the counter substrate, a counter electrode which generates electric fields between the counter electrode and the pixel electrodes is formed over the TFT substrate so as to perform driving of the liquid crystal, and an orientation film aligns the liquid crystal, color filters and the like. In FIG. 1, for the sake of brevity, only the structure of the color filters, the corresponding pixel electrodes formed over the TFT substrate, and boundaries between the transmissive regions and the reflective regions are shown. The color filters are provided corresponding to the pixels shown in FIG. 3. The red color filters RED are provided corresponding to R12, R22, R32 and the like, not to mention the pixels R11, R21, R31 on the TFT substrate. Here, to discriminate the structure shown in FIG. 1 from the structure shown in FIG. 3, the RED pixels are indicated in the drawing such that C is fixed to the respective head portions of the pixels. The same goes for the green color filters GREEN and the blue color filters BLUE. Further, the pixels which display red are formed along one drain line as shown in FIG. 3. Accordingly, the color filters may be individually formed for respective pixels which indicate red. However, as shown in FIG. 1, one color filter may be formed by continuously connecting respective red display pixels parallel to the drain line. The same goes for green and blue color filters. Here, openings formed in the color filters which constitute the features of the present invention will be explained later.

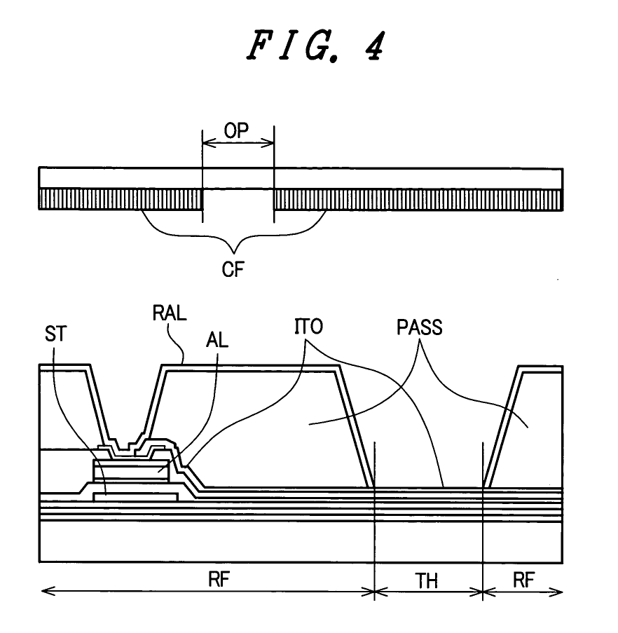

FIG. 4 is a cross-sectional view of the TFT substrate and the counter substrate on which the color filters are formed, taken along a line IV-IV in FIG. 3 and FIG. 1. Liquid crystal is filled between the TFT substrate and the counter substrate. To a metal layer AL made of aluminum or the like, to which the source electrode of the thin film transistor is connected, a transparent electrode ITO and a metal layer RAL made of aluminum or the like, which has functions of a pixel electrode and a reflection member, are connected. In this embodiment, an organic film PASS is formed over the transparent electrode and the metal layer RAL is formed over the organic film, and, hence, a contact hole is formed in the organic film formed over the metal layer AL. Since the metal layer RAL plays both the role of the pixel electrode and the role of a reflection member, the metal layer RAL is referred to as a reflection electrode. In FIG. 4, a portion where the reflection electrode RAL is formed constitutes a reflective region RF, and a region where the reflection electrode RAL does not cover the transparent electrode ITO constitutes a transmissive region TH. In this embodiment, the organic film in the transmissive region is also removed. Further, between the metal layer AL, which is connected to the source electrode of the TFT, and the substrate, a hold capacitance line ST for generating the hold capacitance is formed.

The color filters CF are formed over the counter substrate side. In the transmissive region TH, light from a backlight, which is formed over a back surface of the TFT substrate, appears on a display screen in a colored state after passing through the color filter. On the other hand, an opening portion (a cut) OP is formed in the color filter in the reflective region. In the reflective region, light from the display screen is incident on the reflection electrode via the color filter and the opening portion where the color filter is not formed. Further, the light reflected on the reflection electrode appears on the display screen via the color filter and the opening of the color filter. In this manner, in actual operation, light which does not pass through the color filter exists, and, hence, even when a color filter having high color purity is used, a lowering of the reflective characteristics can be prevented.

Here, the openings formed in the color filters, which feature the present invention shown in FIG. 1, will be explained in detail. The pixel row CR11, CG11, CB11, CR12 which is arranged at the uppermost portion of FIG. 1 is formed of pixels which are controlled by the gate line which is illustrated at the uppermost portion in FIG. 3 (hereinafter referred to as the first gate line). In the color filter corresponding to the pixel CR11, the first opening portion is formed from the pixel CG11 side, that is, from the right side of the TFT substrate; while, in the color filter corresponding to the pixel CG11, the second opening portion is formed from the pixel CB11 side, that is, from the right side of the TFT substrate. The first opening portion is formed over the pixel electrode of the pixel CR11 displaying red and over the pixel-CG11-side peripheral portion of the periphery of the pixel electrode. Further, the second opening portion is formed over the pixel electrode of the pixel CG11 displaying green and over the pixel-CB11-side peripheral portion of the periphery of the pixel electrode.

On the other hand, the pixel row CR21, CG21, CB21, CR22 which is the second row from the above as seen in the drawing consists of pixels which are controlled by the gate line illustrated as the second row line from the above in FIG. 3 (hereinafter referred to as the second gate line). In the color filter corresponding to the pixel CR21, the third opening portion is formed from the right side of the pixel CR21 (the side of the pixel displaying blue not shown in the drawing), that is, from the left side of the TFT substrate; while, in the color filter corresponding to the pixel CG21, the second opening portion is formed from the pixel CR21 side, that is, from the left side of the TFT substrate. The third opening portion is formed over the pixel electrode of the pixel CR11 displaying red and over the left-pixel-side peripheral portion (not shown in the drawing) of the periphery of the pixel electrode. Further, the fourth opening portion is formed over the pixel electrode of the pixel CG21 displaying green and over the pixel-CR21-side peripheral portion of the periphery of the pixel electrode. The pixel row CR31, CG31, CB31, CR32 of the third row from above as seen in the drawing are pixels which are controlled by the gate line illustrated in the third row from above in FIG. 3, wherein the opening portions which are formed in the color filters corresponding to these pixels are formed at positions equal to the positions of the opening portions formed in the color filters corresponding to the pixels controlled by the above-mentioned first gate line. Although not shown in the drawing, with respect to the pixel row which is formed below the pixel row of the above-mentioned third row, the opening portions are formed at positions equal to the opening portions formed in the color filters corresponding to the pixel row controlled by the above-mentioned second gate line.

For example, in fixing the TFT substrate and the counter substrate, when the counter substrate is displaced with respect to the TFT substrate in the left direction as seen in the drawing, for example, in the pixel row which is controlled by the first gate line, areas of the opening portions of the color filters corresponding to the pixel electrodes for red display and green display are increased. That is, the area of the opening portion for the portion of the red color filter that is overlapped relative to the pixel electrode for red display and the area of the opening portion of the green color filter that is overlapped relative to the pixel electrode for green display are increased. To the contrary, in the pixel row controlled by the second gate line, the area of the opening portion of the color filter corresponding to the pixel electrode of the red display and the area of the opening portion of the color filter corresponding to the pixel electrode for green display are decreased. That is, the area of the opening portion of the red color filter that is overlapped relative to the pixel electrode for red display and the area of the opening portion of the green color filter that is overlapped relative to the pixel electrode for green display are decreased. Accordingly, even when the TFT substrate and the counter substrate are displaced from each other, with respect to the whole display panel, there is no change with respect to the area of the opening portion of the color filter corresponding to the pixel electrode for the red display and the area of the opening portion of the color filter corresponding to the pixel electrode for the green display. By fixing the areas of the opening portion corresponding to red and green within the display panel, it is possible to prevent a lowering of the color reproducibility at the time of reflection. Here, the above-mentioned color filter is formed in the reflective region RF in the pixel and is not formed in the transmissive region TH. The same goes for the embodiments described hereinafter.

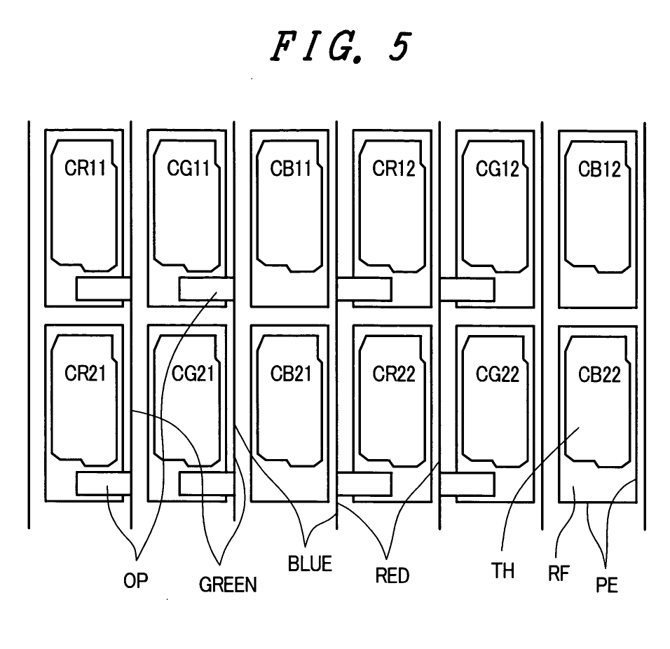

FIG. 5 is a view which shows the second embodiment of the present invention. Since the constitution of the TFT substrate side is substantially equal to the constitution shown in FIG. 2, a repeated explanation thereof is omitted and only the constitution of the color filters corresponding to the color filters shown in FIG. 1 is shown. With respect to the feature of the second embodiment, although portions where the opening portions are formed are made different for every gate line in the first embodiment, in this embodiment, the opening portions are formed at the same portions for every gate line, while portions where the opening portions are formed are different for every drain line. In the drawing, the pixel row CR11, CR12 which is arranged at the leftmost portion in the drawing, the pixel row CG11, CG21 which is arranged at the right side of the pixel row CR11, CR21, and the pixel row CB11, CB21, which is arranged at the right side of the pixel row CG11, CG21 are pixels which are controlled by the drain line which is illustrated at the leftmost portion in FIG. 3, the drain line which is arranged at the right side of the drain line and the drain line which is further arranged at the right side of the drain line. In the color filter corresponding to the pixel CR11, the first opening portion is formed from the pixel CG11 side, that is, from the right side of the TFT substrate, while in the color filter corresponding to the pixel CG11, the second opening portion is formed from the pixel CB11 side, that is, from the right side of the TFT substrate. The first opening portion is formed over the pixel electrode of the pixel CR11 displaying red and over the pixel-CG11-side peripheral portion of the periphery of the pixel electrode. Further, the second opening portion is formed over the pixel electrode of the pixel CG11 displaying green and over the pixel-CB11-side peripheral portion of the periphery of the pixel electrode.

Further, pixels CR12, CG12, CB12 which are arranged close to the pixels CR11, CG11, CB11 and are connected to the same gate line as the pixels CR11, CG11, CB11 will be considered. In the color filter corresponding to the pixel CR12, the third opening portion is formed from the pixel CB11 side, that is, from the left side of the TFT substrate, while in the color filter corresponding to the pixel CG12, the fourth opening portion is formed from the pixel CR12 side, that is, from the left side of the TFT substrate. The third opening portion is formed over the pixel electrode of the pixel CR12 displaying red and over the pixel-CB11-side peripheral portion of the periphery of the pixel electrode. Further, the fourth opening portion is formed over the pixel electrode of the pixel CG12 displaying green and over the pixel-CR12-side peripheral portion of the periphery of the pixel electrode.

In the second embodiment, three drain lines which supply pixel signals to the pixels displaying red, green, blue are assumed as one set and the portions where the opening portions are formed in the color filters are made different for every neighboring set. Portions where the opening portions are formed for every gate line are the same. The change of opening portions due to the displacement of the TFT substrate and the counter substrate is substantially equal to the displacement described in connection with the first embodiment.

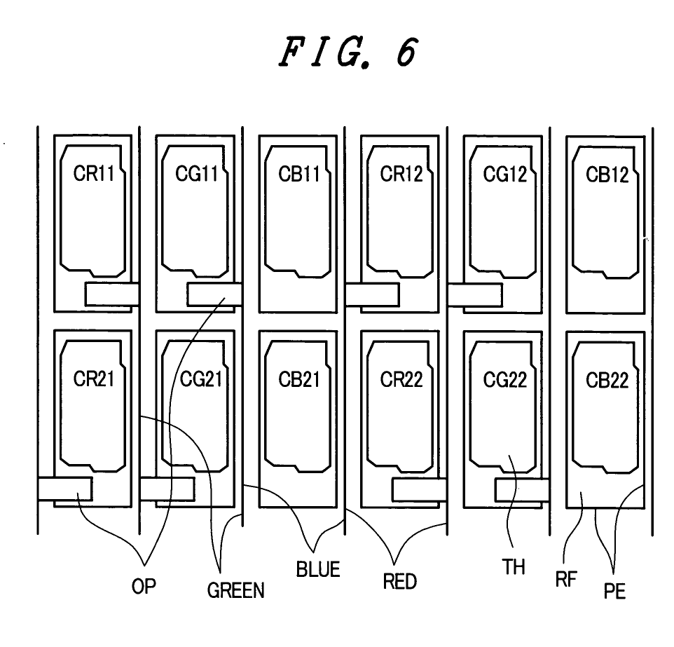

FIG. 6 is a view which shows the third embodiment of the present invention. In the same manner as the second embodiment, only the constitution of the color filters corresponding to the color filters shown in FIG. 1 is shown. This embodiment is characterized by the combination of the first embodiment and the second embodiment. That is, the three-drain-line set corresponding to one red display pixel, one green display pixel and one blue display pixel and another drain line set which is arranged close to the former drain line set are different from each other with respect to the portions where the opening portions are formed in the color filters. Further, the above-mentioned pixels of three colors are different from the pixels of three colors of the gate line arranged close to the gate line corresponding to the former pixels of three colors with respect to the portions where the opening portions are formed in the color filters. The change of opening portions due to the displacement of the TFT substrate and the counter substrate is substantially equal to that in the first embodiment.

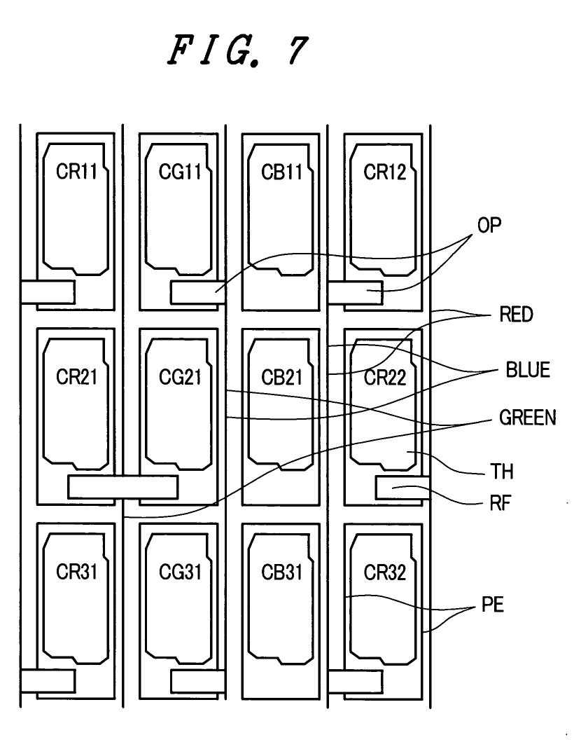

FIG. 7 is a view showing the fourth embodiment of the present invention. This embodiment is a modification of the first embodiment. In this embodiment, with respect to the pixel row CR11, CG11, CB11, CR12 which constitutes the first row from above as seen in the drawing and is controlled by the first gate line, the shapes of the opening portions formed in the color filters corresponding to the pixels of the pixel row are different from each other. That is, in the color filter corresponding to the pixel CR11, the first opening portion is formed from the left side of the pixel CR11 (not shown in the drawing); while, in the color filter corresponding to the pixel CG11, the second opening portion is formed from the pixel-CB-11 side, that is, from the right side of the TFT substrate. The first opening portion is formed over the pixel electrode of the pixel CR11 displaying red and over the peripheral portion at the left-side pixel side (not shown in the drawing) of the periphery of the pixel electrode. Further, the second opening portion is formed over the pixel electrode of the pixel CG11 displaying green and over the peripheral portion at the pixel-CB11-side pixel side of the periphery of the pixel electrode.

On the other hand, the pixel row CR21, CG21, CB21, CR22 which constitutes the second row from above as seen in the drawing is formed of pixels which are controlled by the gate line illustrated in the second row from above in FIG. 3 (hereinafter referred to as the second gate line). The third opening portion is formed in the color filter corresponding to the pixel CR21 and the color filter corresponding to the pixel CG21 such that the third opening portion bridges over both color filters. The third opening portion is formed over the pixel electrode of the pixel CR21 displaying red, above the pixel electrode of the pixel CG21 displaying green, and above peripheral portions of the pixel CR21 and the pixel CG21 which constitute an intermediate portion between these pixel electrodes. The change of opening portions due to the displacement of the TFT substrate and the counter substrate is substantially equal to that in the first embodiment.

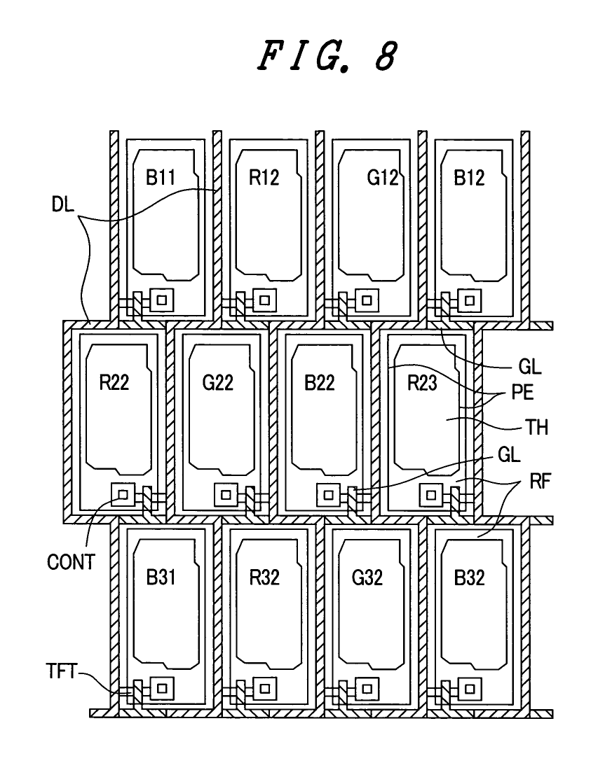

FIG. 8 is a view showing the fifth embodiment of the present invention. This embodiment differs from the embodiment shown in FIG. 3 with respect to the constitution of the pixels formed over the TFT substrate. In the above-mentioned embodiment shown in FIG. 3, the gate lines and the drain lines are formed in parallel to the sides of the substrate and the pixels are also formed in a grid pattern. However, in this embodiment, although the gate lines are formed in parallel to the sides of the substrate, the drain lines are formed in a zigzag shape. That is, the pixel which is connected to one gate line is arranged in a displaced state with respect to the pixel which is connected to the neighboring gate line. This is the so-called delta arrangement. This embodiment adopts the pixel constitution in which the pixel which is connected to the neighboring gate line is displaced by ½ pixel. However, the colors which the pixels connected to the drain line display are equal. For example, the drain line which is connected to the pixel G12 displaying green is connected to the pixels G22 and G32. That is, when the display color is not taken into account, the pixel is formed with the displacement of ½ pixel. On the other hand, when the display color is taken into account, the pixel is formed with the displacement of 3/2 pixel. It is needless to say that the present invention is not limited to the pixel arrangement of this embodiment and the pixel arrangement can be modified without departing from the technical concept of the present invention.

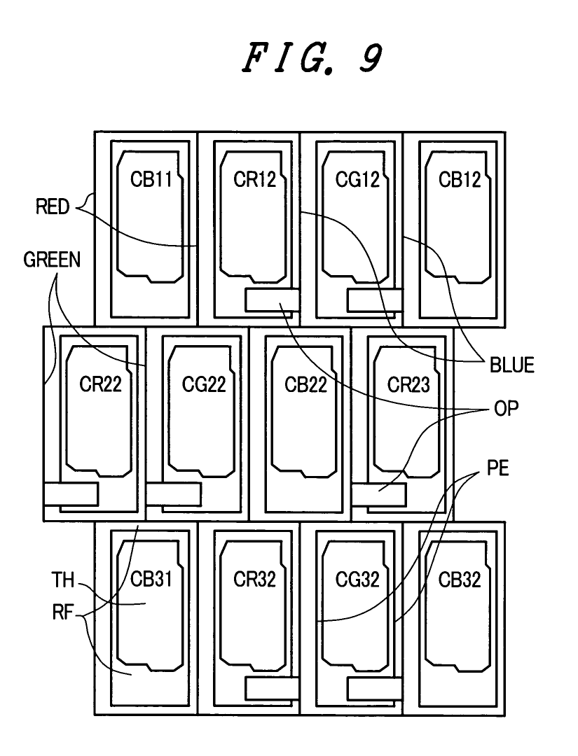

FIG. 9 shows the color filters of the fifth embodiment shown in FIG. 8. The opening portions which feature the present invention are also formed in these color filters. The pixel row CB11, CR12, CG12, CB12, which constitutes the first row from above as seen in the drawing, is formed of pixels which are controlled by the gate line illustrated in the first row from above in FIG. 8 (hereinafter referred to as the first gate line). In the color filter corresponding to the pixel CR12, the first opening portion is formed from the pixel CG12 side, that is, from the right side of the TFT substrate; while, in the color filter corresponding to the pixel CG12, the second opening portion is formed from the pixel CB12 side, that is, from the right-side side of the TFT substrate. The first opening portion is formed over the pixel electrode of the pixel CR12 displaying red and over the pixel-CGI2-side peripheral portion of the periphery of the pixel electrode. Further, the second opening portion is formed over the pixel electrode of the pixel CG12 displaying green and over the pixel-CB12-side peripheral portion of the periphery of the pixel electrode.

On the other hand, the pixel row CR22, CG22, CB22, CR23 which constitutes the second row from as seen above in the drawing is formed of pixels which are controlled by the gate line illustrated in the second row from above in FIG. 8 (hereinafter referred to as the second gate line). In the color filter corresponding to the pixel CR22, the third opening portion is formed from the right side of the pixel CR22 (the blue-display pixel side not shown in the drawing), that is, from the left side of the TFT substrate; while, in the color filter corresponding to the pixel CG22, the fourth opening portion is formed from the pixel CR22 side, that is, from the left side of the TFT substrate. The third opening portion is formed over the pixel electrode of the pixel CR22 displaying red and over the left-pixel-side peripheral portion (not shown in the drawing) of the periphery of the pixel electrode. Further, the fourth opening portion is formed over the pixel electrode of the pixel CG22 displaying green and over the pixel-CR22-side peripheral portion of the periphery of the pixel electrode.

The pixel row CB31, CR32, CG32, CB32 which constitutes the third row from above as seen in the drawing is formed of pixels which are controlled by the gate line illustrated in the third row from above in FIG. 8. Here, the opening portions formed in the color filters which correspond to these pixels are formed in the same portions as the opening portions formed in the color filters corresponding to the pixels which are controlled by the above-mentioned first gate line. Although not shown in the drawing, with respect to the pixel row which is formed below the pixel row at the above-mentioned third row, the opening portions are formed at the same positions as the color filters corresponding to the pixel row which is controlled by the above-mentioned second gate line. The change of opening portions due to the displacement of the TFT substrate and the counter substrate is substantially equal to that in the first embodiment.

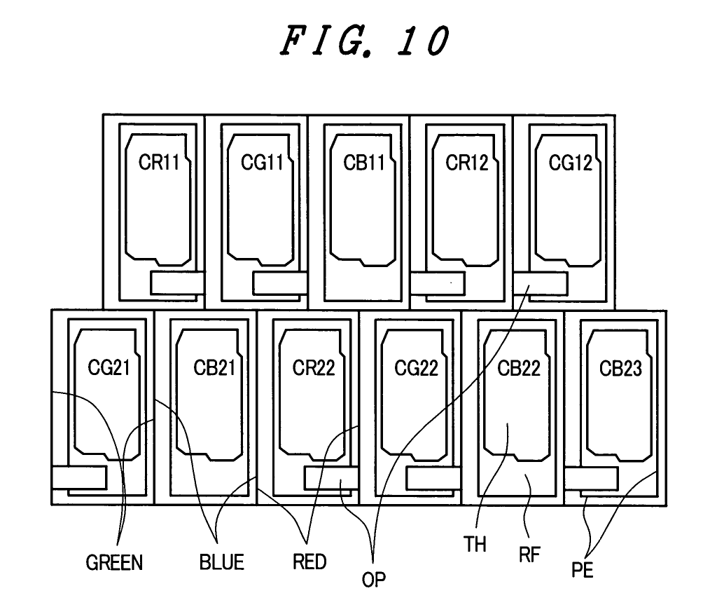

FIG. 10 shows the color filters of the sixth embodiment of the present invention. This embodiment is characterized in that the red display pixel, the green display pixel and the blue display pixel, which are connected to one gate line, are formed into one combination and the portions where the opening portions are formed are different for every combination connected to one gate line. In the color filter corresponding to the pixel CR11, the first opening portion is formed from the pixel CG11 side, that is, from the right side of the TFT substrate; while, in the color filter corresponding to the pixel CG11, the second opening portion is formed from the pixel CB11 side, that is, from the right side of the TFT substrate. The first opening portion is formed over the pixel electrode of the pixel CR11 displaying red and over the pixel-CG11-side peripheral portion of the periphery of the pixel electrode. Further, the second opening portion is formed over the pixel electrode of the pixel CG11 displaying green and over the pixel-CB11-side peripheral portion of the periphery of the pixel electrode. Further, with respect to the pixels CR12, CG12 which are connected to the same gate line to which the pixels CR11, CG11, CB11 are connected, in the color filter corresponding to the pixel CR12, the third opening portion is formed from the pixel CB11 side, that is, from the left side of the TFT substrate, while in the color filter corresponding to the pixel CG12, the fourth opening portion is formed from the pixel CR12 side, that is, from the left side of the TFT substrate. The third opening portion is formed over the pixel electrode of the pixel CR12 displaying red and over the pixel-CB11-side peripheral portion of the periphery of the pixel electrode. Further, the fourth opening portion is formed over the pixel electrode of the pixel CG12 displaying green and over the pixel-CR12-side peripheral portion of the periphery of the pixel electrode.

Further, pixels CR22, CG22 which are connected to the gate line arranged close to the above-mentioned gate line and are also connected to the pixels CR12 and CG12 will be considered. In the color filter corresponding to the pixel CR22, the fifth opening portion is formed from the pixel CG22 side, that is, from the right side of the TFT substrate, while in the color filter corresponding to the pixel CG22, the sixth opening portion is formed from the pixel CB22 side, that is, from the right side of the TFT substrate. The fifth opening portion is formed over the pixel electrode of the pixel CR22 displaying red and over the pixel-CG22-side peripheral portion of the periphery of the pixel electrode. Further, the sixth opening portion is formed over the pixel electrode of the pixel CG22 displaying green and over the pixel-CB22-side peripheral portion of the periphery of the pixel electrode. That is, the portions where the opening portions are formed in the color filters corresponding to the pixels CR11, CG11, CB11 become equal to the portions where the opening portions are formed in the color filters corresponding to the pixels CR22, CG22, CB22.

It is needless to say that, in the sixth embodiment, the portions where the opening portions are formed in the color filters corresponding to the pixels CR22, CG22, CB22 and the portions where the opening portions are formed in the color filters corresponding to the pixels CR12, CG12, CB12 (not shown in the drawing) may be set so as to be equal. In this case, the portions where the opening portions are formed in the color filters corresponding to the pixels CR11, CG11, CB11 become equal to the portions where the opening portions are formed in the color filters corresponding to the pixels CR21 (not shown in the drawings), CG21, CB21.

Although the liquid crystal display device of the present invention has been explained heretofore, it is needless to say that the present invention is not limited to the above-mentioned constitutions and various modifications are conceivable without departing from the technical concept of the present invention. For example, in the above-mentioned constitutions, the pixel electrodes are formed over the TFT substrate and the counter electrodes are formed over the substrate which faces the TFT substrate in an opposed manner. However, as in the case of a lateral electric field type (IPS-type) liquid crystal display device, it is possible to apply the present invention to the color filters corresponding to the reflective regions of the semi-transmissive type liquid crystal display device which forms the pixel electrodes and the counter electrodes only on the TFT substrate side.

Further, it is possible to provide a raised portion in a pixel and apply the present invention to the color filters corresponding to the reflective regions of the VA-type semi-transmissive type liquid crystal display device which aligns the liquid crystal in the vertical direction.

Further, in the above-mentioned embodiment, as the constitution of the reflection members which reflect the light incident from the counter substrate side toward the counter substrate side, metal reflection films which are electrically connected with the transparent electrodes which constitute the pixel electrode formed between the substrates have been described. However, the reflection members are not particularly limited in this way. For example, the reflection members may be formed of metal in a floating state or metal which is connected with a holding-capacitance line which is formed in the inside of the pixel. Also, the reflection members may be made of metal except for aluminum.

Still further, the reflection members may be formed in the inside of the backlight. For example, the reflection members may be formed between an optical sheet such as a diffusion sheet in the inside of the backlight and the TFT substrate. Further, the reflection members may be mounted on a back side of the light guide body, that is, on a surface side of the light guide body away from the TFT substrate or on portions of the fluorescent tube away from the TFT side.

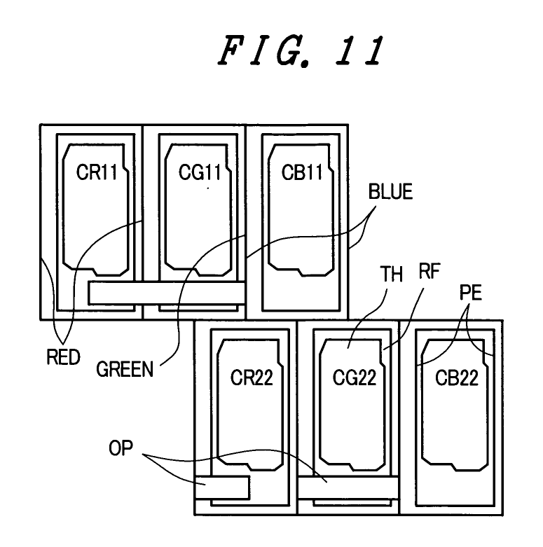

Further, in this specification, the area of the opening portion formed in each pixel is not particularly referred to. However, the area of the opening portion can be suitably changed provided that (the area of the opening portion of the green display pixel) is equal to or larger than (the area of the opening portion of the red display pixel), (the area of the opening portion of the red display pixel) is equal to or larger than (the area of the opening portion of the blue display pixel), and (the area of the opening portion of the blue display pixel) is 0 or more. For example, as shown in FIG. 11, in the color filter corresponding to the pixel CG11 displaying green, the opening portion may be formed from the pixel CR11 side (the left side of the TFT substrate) to the CB11 side (the right side of the TFT substrate). Although the constitution shown in FIG. 11 has been described corresponding to the constitution shown in FIG. 9, it is possible to apply the constitution shown in FIG. 11 to the other embodiments.

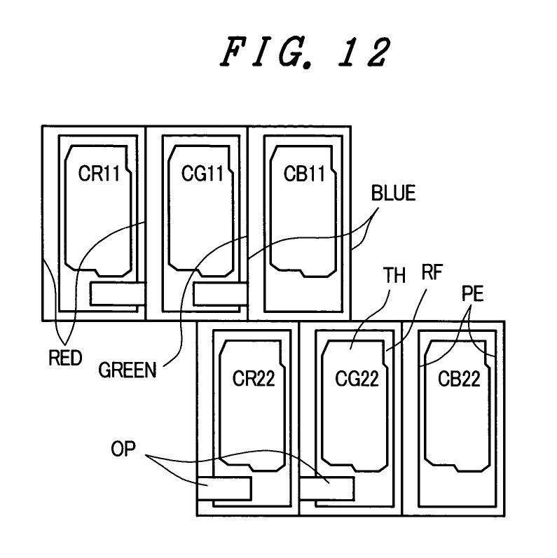

Further, in FIG. 12, each opening portion formed in the color filter does not reach an end portion of the color filter. Due to such a constitution, it is possible to provide a greater tolerance with respect to the displacement between the TFT substrate and the counter substrate than the above-mentioned embodiments.

Although the constitution shown in FIG. 12 is also described as corresponding to the constitution shown in FIG. 9, it is possible to apply the constitution shown in FIG. 12 to the other embodiments. On the other hand, it is also possible to form the opening portion such that the opening portion projects to reach the neighboring color filter. Further, although the opening portion is not formed in the color filter corresponding to the blue display pixel in this embodiment, it is possible to form the opening portion in the blue color filter to meet a request of a client or the like. Also in this case, it is possible to apply the constitution of the present invention to such a constitution.

Further, in this embodiment, although an explanation has been made with respect to the case in which the color filters are formed over the counter substrate side, it is possible to form the color filters on the TFT substrate side. Further, in this embodiment, although the portions where the opening portions are formed are made different for every neighboring gate line or every neighboring set of drain lines, such portions where the opening portions are formed may be made different for every two or more gate lines or for every two or more sets of drain lines.

As can be clearly understood from the foregoing explanation, according to the present invention, it is possible to provide a semi-transmissive type liquid crystal display device which exhibits excellent color characteristics.

1. A liquid crystal display device comprising:
a first substrate on which a plurality of pixel electrodes are formed;
a second substrate which faces the first substrate in an opposed manner;
color filters which are formed between the first substrate and the second substrate;
reflection members which reflects light incident from the second substrate side; and
a backlight which is provided outside the first substrate, wherein
in the color filters which correspond to first pixel electrodes among the plurality of pixel electrodes, opening portions are formed from sides close to a first side of the first substrate, and in the color filters which correspond to second pixel electrodes among the plurality of pixel electrodes, opening portions are formed from sides close to a second side of the first substrate which face the first side in an opposed manner.

2. A liquid crystal display device according to claim 1, wherein the color filters which correspond to the first pixel electrodes and the color filters which correspond to the second pixel electrodes are red color filters, and the first pixel electrodes and the second pixel electrodes are connected with the same drain line and are connected with neighboring gate lines.

3. A liquid crystal display device according to claim 2, wherein the liquid crystal display device includes third pixel electrodes which are connected to the gate line to which the first pixel electrodes are connected and are arranged close to the first pixel electrodes and fourth pixel electrodes which are connected to the gate line and are arranged close to the third pixel electrodes, wherein the color filters which correspond to the third pixel electrodes are green color filters, the color filters which correspond to the fourth pixel electrodes are blue color filters, and opening portions are formed in the color filters which correspond to the third pixel electrodes.

4. A liquid crystal display device according to claim 3, wherein the opening portions formed in the color filters corresponding to the third pixel electrodes are formed from sides close to the first side.

5. A liquid crystal display device according to claim 3, wherein the opening portions formed in the color filters corresponding to the third pixel electrodes may be formed from sides close to the second side.

6. A liquid crystal display device according to claim 3, wherein an area of the opening portion formed in the color filter corresponding to the third pixel electrode is set larger than an area of the opening portion formed in the color filter corresponding to the first pixel electrode.

7. A liquid crystal display device according to claim 3, wherein the opening portions formed in the color filters corresponding to the third pixel electrodes are formed from the first side to the second side.

8. A liquid crystal display device according to claim 1, wherein
the first pixel electrodes and the second pixel electrodes are connected to the same gate line,
the color filters corresponding to the first pixel electrodes and the color filters corresponding to the second pixel electrodes are red color filters, and
between the first pixel electrode and the second pixel electrode, the third pixel electrode displaying green and the fourth pixel electrode displaying blue which are connected to the gate line are formed.

9. A liquid crystal display device according to claim 8, wherein the color filter corresponding to the third pixel electrode is configured to have an opening portion formed from a side close to the first side.

10. A liquid crystal display device according to claim 8, wherein the color filter corresponding to the third pixel electrode has an opening portion formed from a side close to the second side.

11. A liquid crystal display device according to claim 8, wherein an area of the opening portion formed in the color filter corresponding to the third pixel electrode may be set larger than an area of the opening portion formed in the color filter corresponding to the first pixel electrode.

12. A liquid crystal display device according to claim 8, wherein the opening portions formed in the color filters corresponding to the third pixel electrodes are formed from the first side to the second side.

13. A liquid crystal display device according to claim 8, wherein the liquid crystal display device is configured to include fifth pixel electrodes which are connected to the gate line arranged close to the gate line and to the drain line to which the first pixel electrodes are connected and display red, wherein the color filter corresponding to the fifth pixel electrode includes an opening portion arranged from a side close to the first side.

14. A liquid crystal display device according to claim 8, wherein the liquid crystal display device is configured to include fifth pixel electrodes which are connected to the gate line arranged close to the gate line and to the drain line to which the first pixel electrodes are connected and display red, wherein the color filter corresponding to the fifth pixel electrode includes an opening portion arranged from a side close to the second side.

15. A liquid crystal display device according to claim 8, wherein an opening portion is not formed in the color filter corresponding to the fourth pixel electrode.

16. A liquid crystal display device according to claim 8, wherein a spacer is formed over the fourth pixel electrode.

17. A liquid crystal display device according to any one of preceding claims 1 to 16, wherein the reflection members are metal films which are formed between the first substrate and the second substrate.

18. A liquid crystal display device according to claim 17, wherein the reflection members are electrically connected with the plurality of respective pixel electrodes.

19. A liquid crystal display device according to any one of preceding claims 1 to 16, wherein the reflection members are formed in the backlight.

20. A liquid crystal display device according to any one of preceding claims 1 to 16, wherein a counter electrode is formed over the second substrate.

21. A liquid crystal display device according to any one of preceding claims 1 to 16, wherein a counter electrode is formed over the first substrate.
